(19) United States
(12) Patent Application Publication
(10) Pub. No.: US 2026/0264917 A1
(43) Pub. Date: Sep. 10, 2026

(54) SYSTEM FOR PLACING A LABEL ON AN OBJECT AND A METHOD THEREOF

(71) Applicant: Logistics and Supply Chain MultiTech R&D Centre Limited, Pok Fu Lam (HK)

(72) Inventor: Man Hon Chung, Pok Fu Lam (HK)

(21) Appl. No.: 19/071,914

(22) Filed: Mar. 6, 2025

(51) Int. Cl. B65C 9/40; B65C 3/08; B65C 9/26

(52) U.S. Cl. CPC B65C 9/40; B65C 3/08; B65C 9/26

(57) ABSTRACT

A system for placing a label on an object includes an image capturing module arranged to capture an image of a real-world environment with an object for placement of a label; an object recognition processor arranged to process the captured image thereby identifying the point clouds associated with an area on the surface of the object, wherein the object recognition processor is arranged to determine a suitable label placement position based on the combination of the identified point clouds and predefined parameters associated with the label; and a robotic controlled apparatus arranged to apply the label onto the suitable label placement position such that the label is adhere to the object. A method for placing a label on an object is also disclosed.

### TECHNICAL FIELD

The present invention relates to a system for placing a label on an object and a method thereof, and more particularly, although not exclusively, to a system for placing a label on an object and a method thereof, wherein the attributes of the object is unknown before the object is scanned.

### BACKGROUND

E-commerce covers a wide range of businesses, from consumer-based retail sites, through auction or music sites, to business exchanges trading goods and services between overseas corporations. The turnover rates of goods or storage items in E-commerce warehouses are fast, while the goods are in small quantities but in vast varieties. However, existing automation or robotics may not accommodate the daily business operations of the E-commerce warehouse.

For instance, the stored items and the boxes for packing these items are generally in irregular shapes, forms, colours and made of materials with different stiffness. Scanning an object for a suitable label placement position on these objects based on predefined parameters associated with the label would be inefficient and slow.

### SUMMARY OF THE INVENTION

In accordance with a first aspect of the present invention, there is provided a system for placing a label on an object comprising:
an image capturing module arranged to capture an image of a real-world environment with an object for placement of a label;

-an object recognition processor arranged to process the captured image thereby identifying the point clouds associated with an area on the surface of the object, wherein the object recognition processor is arranged to determine a suitable label placement position based on the combination of the identified point clouds and predefined parameters associated with the label; and a robotic controlled apparatus arranged to apply the label onto the suitable label placement position such that the label is adhere to the object.

In one embodiment of the first aspect, the object recognition processor is arranged to filter the data points of the point clouds from the identified point clouds based on a predefined parameter thereby removing data point irrelevant to the object from the captured image.

In one embodiment of the first aspect, the object recognition processor is arranged to undergo the localized filtering based on the relationship between neighbor data points.

In one embodiment of the first aspect, the object recognition processor is arranged to merge the filtered data points into one or more segments associated with an area on the surface of the object.

In one embodiment of the first aspect, the object recognition processor is arranged to compare the merged segments with one or more predefined criterions thereby identifying a candidate label placement position on the surface of the object. In one embodiment of the first aspect, the object recognition processor is arranged to process the larger merged segment in a higher priority than the smaller merged segment.

In one embodiment of the first aspect, the object recognition processor is arranged to remove the data points far from the surface of the identified candidate label placement position thereby reducing the dimensionality of the data points associated with the identified candidate label placement position.

In one embodiment of the first aspect, the object recognition processor is arranged to sort the priority of the data points among multiple identified candidate label placement position based on one or more predefined criterions.

In one embodiment of the first aspect, the predefined criterion includes sorting the data points based on the distance of the candidate label placement position from centroid of the object.

In one embodiment of the first aspect, the object recognition processor is arranged to compare the surface area of the candidate label placement position with the surface area of the label.

In accordance with a second aspect of the present invention, there is provided a method for placing a label on an object comprising the steps of:
capturing an image of a real-world environment with an object for placement of a label;
processing the captured image with an object recognition process to identify the point clouds associated with an area on the surface of the object;
determining a suitable label placement position based on the combination of the identified point clouds and predefined parameters associated with the label; and
applying the label onto the suitable label placement position such that the label is adhere to the object.

In one embodiment of the second aspect, the object recognition process is arranged to filter the data points of the point clouds from the identified point clouds based on a predefined parameter thereby removing data point irrelevant to the object from the captured image.

In one embodiment of the second aspect, the object recognition process is arranged to undergo the localized filtering based on the relationship between neighbor data points.

In one embodiment of the second aspect, the object recognition process is arranged to merge the filtered data points into one or more segments associated with an area on the surface of the object.

In one embodiment of the second aspect, the object recognition process is arranged to compare the merged segments with one or more predefined criterions thereby identifying a candidate label placement position on the surface of the object.

In one embodiment of the second aspect, the object recognition process is arranged to process the larger merged segment in a higher priority than the smaller merged segment.

In one embodiment of the second aspect, the object recognition process is arranged to remove the data points far from the surface of the identified candidate label placement position thereby reducing the dimensionality of the data points associated with the identified candidate label placement position

In one embodiment of the second aspect, the object recognition process is arranged to sort the priority of the data points among multiple identified candidate label placement position based on one or more predefined criterions.

In one embodiment of the second aspect, the object recognition process is arranged to sort the data points based on the distance of the candidate label placement position from centroid of the object.

In one embodiment of the second aspect, the object recognition process is arranged to compare the surface area of the candidate label placement position with the surface area of the label.

### BRIEF DESCRIPTION OF THE DRAWINGS

Embodiments of the present invention will now be described, by way of example, with reference to the accompanying drawings in which:

FIG. 1 shows a schematic view of a system in accordance with one embodiment of the present invention;

FIG. 2 shows the detection of optimal label position on a curved suitcase by the system in accordance with one embodiment of the present invention;

FIG. 3 shows the detection of optimal label position on a box case by the system in accordance with one embodiment of the present invention;

FIG. 4 shows the detection of optimal label position on a chair by the system in accordance with one embodiment of the present invention;

FIG. 5 is a schematic view of a conventional template matching with several shortcomings addressed by the present invention;

FIG. 6 is a flow chart showing a method in accordance with one embodiment of the present invention;

FIG. 7 is a schematic view of a method in accordance with one embodiment of the present invention; and

FIG. 8 is a flow chart showing a method in accordance with another embodiment of the present invention.

### DETAILED DESCRIPTION OF THE PREFERRED EMBODIMENTS

Without wishing to be bound by theory, the inventors, through their own research via trials and experimentation, have discovered that existing system and method for placing a label on an object require the scanning of every point of an object is computationally intensive and slow. The efficiency of the existing system and method is limited by the tedious scanning and processing time and thus may not accommodate the daily business operations of the E-commerce warehouse.

To solve or alleviate at least some of the above problems, the present invention discloses a new label affixing system and method which adopt enhanced computer vision algorithms.

Advantageously, the system and method may leverage a low-cost depth sensor and operate on a non-GPU machine, making it feasible for edge computing. By employing a computational algorithm design, including region growing and template matching, the present invention provides a deterministic approach to label affixing.

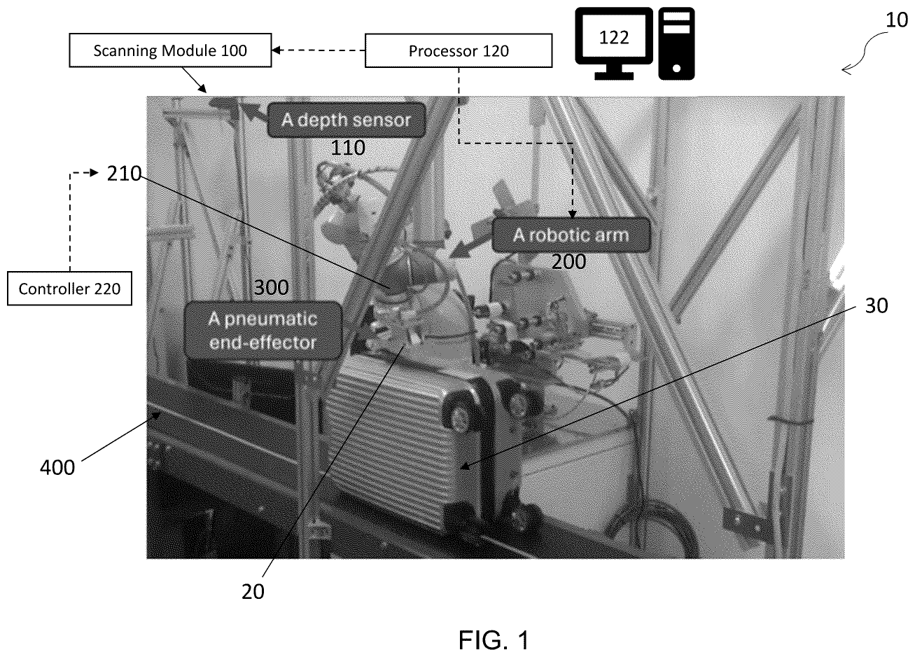

With reference to FIG. 1, there is provided a system 10 for placing a label 20 on an object 30 comprising: an image capturing module 110 arranged to capture an image of a real-world environment with an object 30 for placement of a label 20; an object recognition processor 120 arranged to process the captured image thereby identifying the point clouds 40 associated with an area on the surface of the object 30, wherein the object recognition processor 120 is arranged to determine a suitable label placement position 42 based on the combination of the identified point clouds 40 and predefined parameters associated with the label 20; and a robotic controlled apparatus 200 arranged to apply the label 20 onto the suitable label placement position 42 such that the label 20 is adhere to the object 30.

In this embodiment, there is provided a system 10 which is incorporated in the form of a service robot. The system 10 includes a scanning module 100, a robotic controlled apparatus 200, a target object 30 e.g., a luggage to be scanned by the scanning module 100, a label 20 for affixing on the scanned object 30, e.g., barcode, RFID labels, or any other identifications with delivery address or other stored information, and a label substrate (not shown) e.g., an auto label dispenser for providing labels 20. This system 10 may effectively replicate manual label affixing tasks and enhance efficiency and improve overall workflow in luggage handling. The attributes of the object 30, such as the object's size, shape, surface contours, functional orientation, material composition, stiffness, deflection properties or the like are unknown before the object 30 is scanned by the scanning module 100.

Preferably, the scanning module 100 further includes image capturing module 110 and an object recognition processor 120, such as a computer 122. The image capturing module 110 is arranged to capture an image of the object 30, while the object recognition processor 120 is arranged to identify an area on the surface of the object 30 as the suitable label placement position. In one example embodiment, such suitable label placement position may be a planar region or surface of an object 30 with irregular shape. A label 20, with any arbitrary shapes, may then be applied onto this suitable label placement position and uniformly affixed onto the object 30, thereby assigning a unique identification to the object 30.

Optionally, the image capturing module 110 may further include a depth sensing module or depth camera 110 to facilitate the image capturing of the object 30 from various orientations, thereby identifying the most suitable label placement position among the multi-planes of a three-dimensional object 30 more efficiently. For instance, the depth camera 110 may provide the location of the object 30, for example the depth information to the object recognition processor 120, such that the relative position of the object 30 may be tracked timely and accurately even if the object 30 is under an arbitrary, unpredictable non-uniform motion. More importantly, the shape and profile of the object 30 may also be determined without the object 30 being stationary.

On the other hand, the robotic controlled apparatus 200 may include a robotic member 210, e.g., an industrial arm such as Delta robot or Cartesian robot, and a controller 220 e.g., a microcontroller with embedded applications for manipulating the motion of the robotic member 210 in three dimensions space, based on the programmable input/output and data algorithms. The robotic member 210, actuated by the controller 220, may extract the label 20 from the label substrate and apply the label 20 onto the suitable label placement position. For instance, the robotic member 210 may include a pneumatic effector 300 arranged to pneumatically extract/pick up the label 20 from the label substrate through suctioning, by applying a pneumatically suction pressure, and pneumatically apply/place the label 20 onto the object 30 through blowing, by applying a pneumatically blow pressure. Alternatively, the label 20 may be rolled onto the object 30 with a moveable end effector 300. More advantageously, the label 20 may also be rolled onto an irregularly shaped object 30 with a flexible end effector 300.

Preferably, the object recognition processor 120 may identify the data points of the object 30, in order to identify the generally planar areas on the object 30 as suitable label placement position. As the attributes of the object 30, such as the object 30's size, shape, surface contours, functional orientation, material composition, deflection properties or the like, are unknown, it is advantageous to identify the planar areas on the object 30, thereby choosing the most suitable label placement position, for example, the position with the largest planar area available.

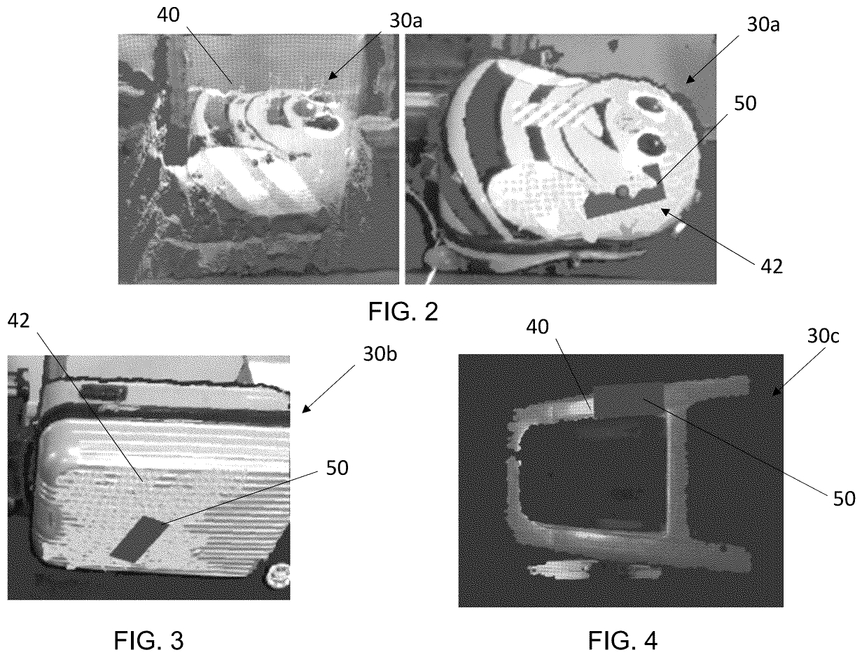

Referring to FIGS. 2 to 4 for some examples of various object 30 which are suitable for the detection of optimal label position 50 by the application of system 10. For instance, the depth camera 110 may capture 3D point clouds 40 of the object 30 in a real-world environment and the object recognition processor 120 may determine the optimal label position 50 on the object 30 based on the data points of the 3D point clouds 40.

Taking the curved suitcase 30a as shown in FIG. 2 as an example, the depth camera 110 may capture 3D point clouds 40 of the curved suitcase 30a and identify the curvature of the surfaces on the suitcase 30a. Those surfaces satisfying the predefined parameters are highlighted as candidate label placement positions 42 and the best fit would be the optimal label position 50 for adhering the label 20. The optimal label position 50 of the box case 30b and the chair 30c may also be determined by using a similar algorithm accordingly.

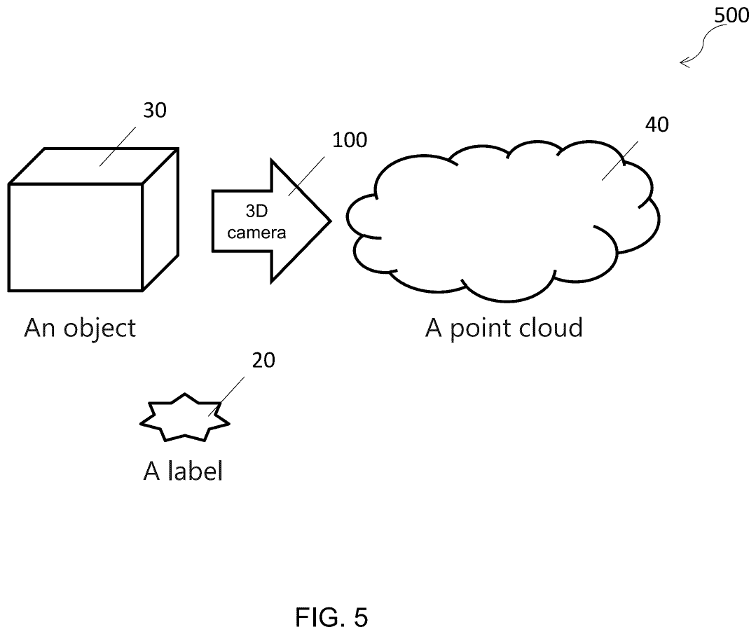

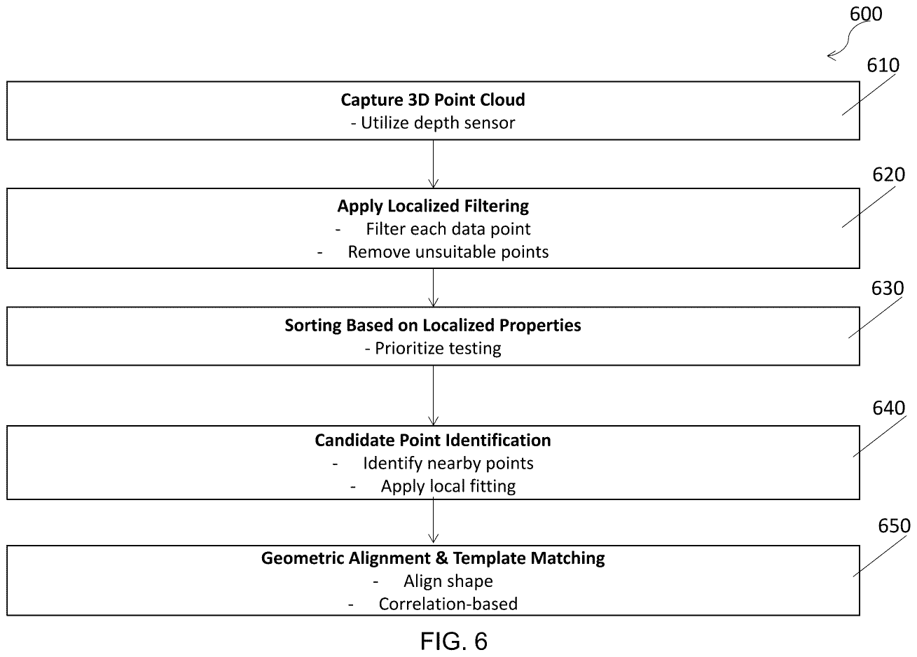

Referring to FIGS. 5 to 6 for the detailed explanation to the function of the object recognition processor 120.

FIG. 5 depicts a schematic view showing a typical flow chart 500 for determining the best position to adhere a label 20 to an object 30. One trivial way is to apply template matching for every point in a point cloud 40, but this is a computationally intensive and a slow way and fails to solve the problems.

FIG. 6 depicts a method and system 600 for automated label affixing using point cloud data 40 in accordance with one example embodiment of the present invention. This method 600 ensures efficient and accurate identification of the optimal surface for label affixing by leveraging point cloud data 40, localized filtering, and advanced geometric and template matching techniques.

Method 600 begins with step 610 of capture 3D point cloud 40. The system may utilize a depth sensor 110 to capture a 3D point cloud 40 of the scene, which includes the object 30 to be labeled. After step 610, method 600 may then proceed to step 620 of applying localized filtering. The system may apply a localized filter to each data point in the point cloud 40. For instance, the system may implement criteria to drastically remove unsuitable points, ensuring only relevant data points are retained.

Method 600 may then proceed to step 630 of sorting based on localized properties. The system may sort the remaining points based on their localized properties. The system may prioritize testing the most suitable points first in subsequent steps 640 to 650. Next, method 600 may then proceed to step 640 of candidate point identification. For each point, the system may identify nearby points to form a candidate region. The system may also apply local fitting to reduce the data dimensionality by one dimension, as fitting typically reduces dimensionality.

Finally, method 600 may proceed to step 650 of geometric alignment and template matching. The system may align the shape of the candidate region with the target template using geometric transformations. For instance, the system may apply correlation-based template matching to ensure the candidate region matches the label template 20.

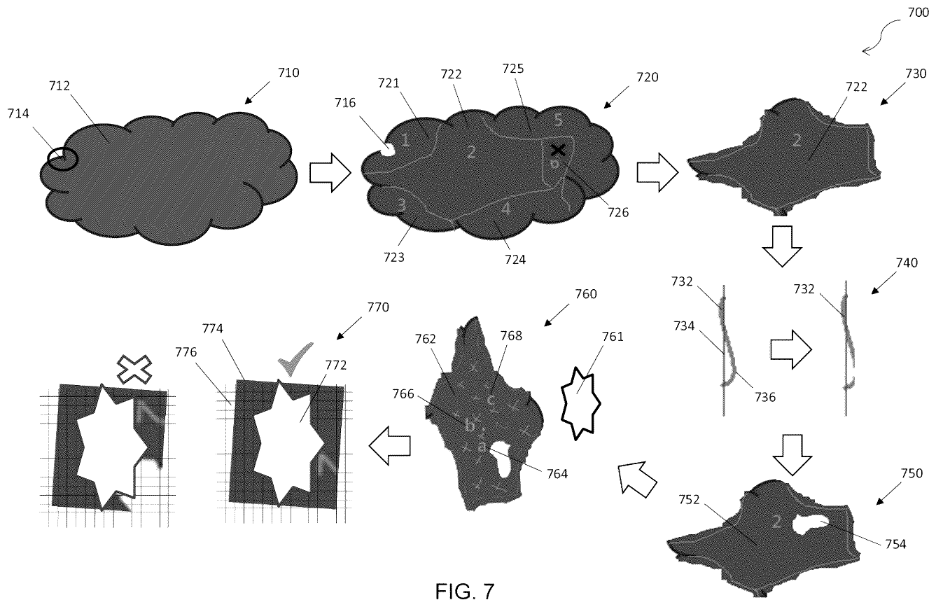

The method 600 will now be further described with reference to the workflow of a method 700 for placing a label 20 on an object 30 as shown in FIG. 7.

Method 700 begins with capturing multi-dimensional data and step 710 of filtering the captured multi-dimensional data. Based on the specific problem, localized filtering is applied to remove a large portion of the data. This filtering aligns with rejection criteria on a localized level and can be calculated efficiently using near neighbor points. For instance, the local curvature of the surface i.e., flatness of the surface on the object 30 can be determine based on the data points 712. Those complicated shapes 714 are excluded from potential candidate points and the data points are removed from the region 716.

After step 710, method 700 may proceed to step 720 of running an optional merging algorithm for clustering the input data points into segments for parallel processing or reject segments that does not meet a suitable criterion. The points are merged to a plurality of different regions e.g., 721 to 726 and the merged segments 721 to 726 are screened based on criterions. For instance, the merged segments may only be sufficient to receive the label 20 only if the surface area is above a predetermined threshold. The surface area of the segment 722 is too small and accordingly all points of that region are rejected. Method 700 may then proceed to step 730 of prioritizing the merged segments. To allocate the resources more efficiently, the larger segment 722 are processed by the processor 120 first over the rest of the segments 721 and 723 to 726.

Following step 730, method 700 may then proceed to step 740 of projecting to 2D and removing points far from the plane of the segment 722. The data points can be projected to reduce their dimensionality, making the subsequent template matching at step 770 more efficient due to the reduced dimension. In this process, the 3D region of segment 722 is approximated to 2D plane. For instance, the cross-sectional side view of 722 may be simulated by the curved surface 732 formed by the data points with respect to an axis 734 and shows that the segment 722 is uneven with respect to the axis 734. To reduce the amount of data point to be processed by the processor 120, those data points 736 which are farthest away from the axis 734 are removed.

Method 700 may then proceed to step 750 of transforming from 3D to 2D. Here, a partial segment 754 is removed from the segment 722 so as to obtain a 2D plane 752 made of reduced data points. Furthermore, the data points can be sorted based on criteria that prioritize the most likely candidates to meet the requirements. The algorithm can stop once sufficient data points are found to resolve the problem.

Subsequently, method 700 may then proceed to step 760 of determining its distance from centroid criterions and sorting points based on the centroid criterions. A label 761 would be placed on the 2D plane 762 and determine a plurality of potential points 764, 766 and 768. Preferably, the label 761 would better be adhered at the centre of a region made up by potential points 764, 766 and 768. These points would be sorted based on its distance from the centre of 2D plane 762. The potential point with the shortest distance from the centre of 2D plane 762 would be selected.

Finally, method 700 may proceed to step 770 of template matching. For instance, there is provided a grid-based solution for template matching between the label 772 and the candidate surface 774 for adhering the label 772 thereon. When counting support points, a bin counting approach can be used for counting the sufficient surface for adhering the label 772. The grid density of the bins 776 can be defined based on the label 772's property i.e., the grid coarse could be adjusted based on the problems. If occupying count meets a threshold, then this testing point is one selected candidate point. During the template matching step 770, data can be further refined based on criteria, such as transitioning from dense shapes to perimeter points, to expedite processing by the processor 120.

In one example embodiment, there is provided an automated label affixing system 10 for conveyor belt operations which is provided for placing a label 20 on an object 30, such as the item prepared for transportation along a transportation system 400, for example a conveyor belt system 400 for transporting luggage 30 as shown in FIG. 1. The system 10 preferably includes a depth sensor 110, a mini workstation 122, and a robotic arm 200 equipped with a pneumatic end-effector 300. The mini workstation 122 may be a computer console/processor 120 for controlling the depth sensor 110 and the robotic arm 200. The depth sensor 110 captures 3D point clouds 40 of objects 30 on a conveyor belt 400. In this system 10, a large volume of objects 30 with irregular shapes, forms, colours and made of materials with different stiffness are being transported along the conveyor belt system 400 and the mini workstation 122 requires fast processing speed. The mini workstation 122 may store a computational algorithm for locating the optimal surface for label affixing.

Preferably, the scanning module 100 is arranged to scan each of the plurality of objects 30 moved by the conveyor belt system 400 along the conveyor belt, for example by capturing the images of the object 30 with depth sensor 110 for suitable label placement position 42 and based on predefined parameters associated with a plurality of labels 20. The captured images may be sent to the computer console 120 for image analysis and object recognition. In one example embodiment, the object recognition processor 120 may identify the point cloud data 40 of the irregularly shaped object 30, for example, by using computational algorithm in order to identify the generally planar areas on the object 30, and thence selecting the most suitable planar area e.g., the largest planar area available as the suitable label placement position 42. Alternatively, the suitable label placement position 42 may be determined based on other user-predefined criteria, e.g., the shape of the label 20 apart from the size of the planar area or in addition to the size of the planar area.

The robotic arm 200, commanded by the computer console 120, is arranged to extract each of the labels 20 from a label source and move the labels 20 to be adjacent to the suitable label placement position 42 of each of the scanned object 30. Optionally, the speed of the conveyor belt 400 may be monitored and adjusted by the computer console 120, thereby allowing the objects 30 to be sufficiently separated.

The robotic arm 200 is further arranged to apply each of the labels 20 onto the suitable label placement positions 42, such that each of the labels 20 may adhere to and placed on the plurality of the objects 30 respectively. Optionally, the labels 20 may be placed on the objects by the robotic arm 200 with the aiding of an effector 300 attached thereto. It would be appreciated by person skilled in the art that the system 10 may also be implemented in a transportation system comprising a plurality of conveyor belt systems 400.

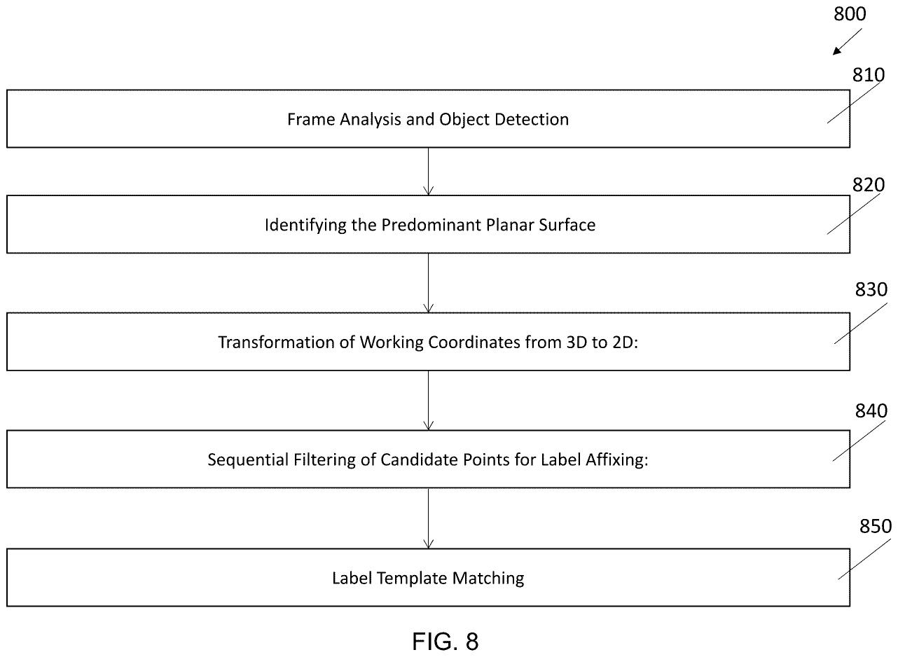

With reference now finally to FIG. 8, the operation workflow 800 of the computational algorithm in accordance with one example embodiment of the present invention will now be further described. The operation workflow 800 for locating the optimal surface for label affixing may comprise the following steps 810 to 850.

Method 800 begins with step 810 of frame analysis and object detection. Initially, step 810 may begin with sub-step a) of capturing raw point cloud data for each frame. First, the raw point cloud of each frame contains thousands of points, and not every frame includes the objects 30 of interest. This initial sub-step a) is to determine whether a frame contains an object 30. Step 810 may then proceed to sub-step b) of calibrating the camera 110 using a checkerboard pattern. Based on the hardware setup, the computational algorithm may calibrate the camera 110 by using a checkerboard pattern.

Next, step 810 may then proceed to sub-step c) of transforming the point cloud coordinates 40 to align with the conveyor belt 400. For each point cloud frame, the computational algorithm may apply a transformation to align the coordinates with the conveyor belt 400. Step 810 may then proceed to sub-step d) of defining a space matching the conveyor belt 400's width and the maximum allowable luggage height. The computational algorithm may define a space that matches the width of the conveyor belt 400, with the height determined by the maximum length of an allowable luggage size.

Step 810 may then proceed to sub-step e) of removing points outside this defined space and subsequently proceed to sub-step f) of applying a voxel grid filter to ensure even point distribution and reduce the point cloud size. Here, the computational algorithm may apply a voxel grid filter to ensure even distribution of points and to further reduce the number of points in the cloud 40. This process helps in maintaining a manageable and efficient dataset for subsequent processing steps 820 to 850. Following sub-step f), if the number of remaining points falls below a predetermined threshold, the computational algorithm may conclude that there is no object 30 on the conveyor belt 400 under the camera 110. Consequently, the computational algorithm will skip the current frame.

Method 800 may then proceed to step 820 of identifying the predominant planar surface. Initially, step 820 may begin with sub-step a) of estimating local surface properties at each 3D point using parallel processing. The computational algorithm may estimate local surface properties at each 3D point in parallel using the OpenMP standard.

Step 820 may then proceed to sub-step b) of computing normals for each point by analyzing its neighborhood using K-Dimensional trees (KD-trees) for efficient nearest-neighbor searches. To compute the normal at a specific point, it is essential to analyze its neighborhood, which includes the surrounding points. Typically, this involves either selecting the N closest points or all points within a certain radius around the target point. Identifying these neighboring points can be challenging if the point cloud 40 is unstructured. KD-trees are employed to expedite this search process, as they are optimized data structures that enable very fast nearest-neighbor searches.

Next, step 820 may proceed to sub-step c) of filtering out points deviating by more than a certain angle from the viewpoint. After estimating the normal of each point based on its neighbors, the computational algorithm may apply a dot product with a unit vector along the z-axis. This sub-step filters out points that deviate by more than a certain angle from the viewpoint, as such points are likely facing downwards and are not accessible by the robotic arms 200.

Next, step 820 may proceed to sub-step d) of applying region growing segmentation to merge points into clusters representing smooth surfaces. The computational algorithm may apply region growing segmentation. This algorithm merges points that are sufficiently close in terms of smoothness constraints, resulting in clusters where each cluster represents a set of points belonging to the same smooth surface. The algorithm operates by comparing the angles between the normals of the points. The computational algorithm empirically set the smoothness threshold, curvature threshold, and minimum cluster size. Finally, step 820 may proceed to sub-step e) of selecting the largest planar surface cluster for further processing. Consequently, the resulting clusters are predominantly planar surfaces. From these clusters, the computational algorithm may select the largest surface for further processing.

Method 800 may then proceed to step 830 of transformation of working coordinates from 3D to 2D. Initially, step 830 may begin with sub-step a) of applying plane segmentation to identify plane-supporting points. After identifying a cluster of planar surfaces, the computational algorithm may apply plane segmentation to the set of points using the Random sample consensus (RANSAC) algorithm. This algorithm helps finding all points within the point cloud 40 that support a plane model.

Step 830 may then proceed to sub-step b) of calculating the angle between the identified plane and the vertical plane. Once the plane model coefficients are obtained, the computational algorithm may calculate the angle between the identified plane and the vertical plane. Step 830 may then proceed to sub-step c) of applying the appropriate transformation matrix for the robotic arm 200's motion matrix. This calculation allows applying the appropriate transformation matrix when determining the motion matrix for the robotic arm 200. Finally, step 830 may proceed to sub-step d) of working within the plane coordinate system to identify the optimal label position 50.

Method 800 may then proceed to step 840 of sequential filtering of candidate points for label affixing. Initially, step 840 may begin with sub-step a) of identifying a planar region and locating a sufficiently flat area for label affixing. At this stage, the computational algorithm has identified a planar region, and the next task is to locate a sufficiently flat area within this region for label affixing. Generally, the chosen position should avoid the edge areas.

Step 840 may then proceed to sub-step b) of applying template matching by computing the mean of points within the cluster and normalizing the data. To find the region, the computational algorithm may apply the classic approach of template matching. The computational algorithm may first compute the mean of the points within the cluster across the x, y, and z coordinates and normalize the data by subtracting this mean from each point. For template matching in sub-step b), the computational algorithm may employ a greedy algorithm, sequentially testing candidate points from the center of the region outward. Next, the computational algorithm may create the point cloud for the label 20, which serves as the template. The label 20 is typically a rectangle, so the computational may generate a rectangular template programmatically. The computational may define the shape formed by these points as (T).

Next, step 840 may proceed to sub-step c) of sorting points by their distance from the centroid and testing candidate points from the center outward. Subsequently, the computational algorithm may sort the points in the point cloud 40 according to their distance from the centroid, beginning with those closest to the center of the plane.

Step 840 may then proceed to sub-step d) of using a KD-tree to identify points within a specified radius and evaluating the candidate area for label affixing. For each candidate point cloud, the computational algorithm may utilize a KD-tree to identify points within a specified radius, equivalent to half the diagonal of the rectangular label 20, and count the number of points within this circle. The computational algorithm may define the shape formed by these points as (A).

The computational algorithm may then apply a formula to evaluate whether the candidate area has a sufficient surface for label affixing. For instance, if the candidate point is at the edge of the region, the circle (A) may resemble a half-pie shape. In such cases, envisioning a rectangular label 20 within this area, there may be insufficient points to securely attach the label 20. This method allows swiftly rejecting unsuitable candidates.

The first criterion is that if the number of points in (A) is less than the number of points in the label template, the candidate can be disregarded. The second criterion is based on geometric properties to further exclude candidates. Since the rectangle (T) is inscribed in the circle (A), the diagonal of the rectangle is equal to the diameter of the circle. Therefore, the radius (r) of the circle can be expressed in terms of the length (x) and width (y) of the rectangle:

$$r = \frac{\sqrt{{x}^{2} + {y}^{2}}}{2}$$

Using the formulas for the areas:

$$Area of the Circle = π {r}^{2}$$

$$Area of the Rectangle = x \times y$$

We can calculate the ratio between the area of the circle and the area of the rectangle. The ratio is given by:

$$Ratio = \frac{Area of the circle}{Area of the Rectangle} = \frac{π {r}^{2}}{x \times y}$$

Now, we can substitute this expression for (r) into the formula and then simplify the expression:

$$Ratio = \frac{π ( {x}^{2} + {y}^{2} )}{4 xy}$$

Hence, by inputting the dimensions of the label 20 into the formula, the computational algorithm can determine the exact ratio for the ideal case.

Next, step 840 may proceed to sub-step e) of applying criteria to reject unsuitable candidates based on point count and geometric properties. The computational algorithm may apply a stringent criterion: if the ratio for the current candidate point is not a certain factor larger than this (e.g., 1.3×), the computational algorithm can reject it due to its less-than-ideal position for label affixing.

Lastly, method 800 may then proceed to the final step 850 of label template matching. Initially, step 850 may begin with sub-step a) of performing eigenvector decomposition to align the candidate shape with the label template 20. The computational algorithm may apply eigenvector decomposition to find the longest axes of shape (T) and (A). Then, the computational algorithm may calculate the angle between the label template shape (T) and the candidate shape (A), and align (A) and (T) along their longest axes.

Step 850 may then proceed to sub-step b) of creating a discrete bin table for the label template and checking if all bins are filled by candidate points. Subsequently, the computational algorithm may create a discrete bin table inspired by the Hough transform, albeit in a simplified manner. The label template shape (T) is discretized into bins of n rows by m columns. For each point in the candidate shape (A), the computational algorithm may determine if it falls into any bins in (T).

Finally, step 850 may proceed to sub-step c) of confirming the candidate shape meets the criteria for a sufficiently flat and dense position for label affixing. After iterating through all points, the computational algorithm may check if all bins are filled. If they are, this candidate shape meets the criteria for being a sufficiently flat and dense position for label affixing.

In one alternative example embodiment, there is provided yet another system for label affixing on irregularly shaped objects 30. The system also includes a depth sensor 110, a mini workstation 122, and a robotic arm 200 with a flexible end-effector 300. The depth sensor 110 may capture 3D point clouds of irregularly shaped objects.

The operation of this alternative embodiment is similar to the operation workflow 800 as aforementioned, except step 810 includes sub-step c) of transforming the point cloud coordinates to align with the workspace instead of the conveyor belt 400 and sub-step d) of defining a space matching the object's expected dimensions instead of the conveyor belt 400's width and the maximum allowable luggage height. The rest of the steps 810 to 850 and their sub-steps are identical to operation workflow 800 and are not reiterated.

Preferably, all these embodiments illustrate the practical application of the method for different scenarios, ensuring efficient and accurate label affixing on various objects 30 using point cloud data 40 and advanced processing techniques.

It will be appreciated by persons skilled in the art that although the embodiments comprising the system 10 or the effector 300 are applied to affixing labels on multiple and irregular objects, these embodiments may also be applied in any other applications such as pick and place automations in warehouse, airport, outdoor gaming, logistics, food and beverage ordering, manufacturing process or the like with minor modifications and without departing from the concept of the present invention.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A system for placing a label on an object comprising:
an image capturing module arranged to capture an image of a real-world environment with an object for placement of a label;
an object recognition processor arranged to process the captured image thereby identifying the point clouds associated with an area on the surface of the object, wherein the object recognition processor is arranged to determine a suitable label placement position based on the combination of the identified point clouds and predefined parameters associated with the label; and
a robotic controlled apparatus arranged to apply the label onto the suitable label placement position such that the label is adhere to the object.

2. A system for placing a label on an object in accordance with claim 1, wherein the object recognition processor is arranged to filter the data points of the point clouds from the identified point clouds based on a predefined parameter thereby removing data point irrelevant to the object from the captured image.

3. A system for placing a label on an object in accordance with claim 2, wherein the object recognition processor is arranged to undergo the localized filtering based on the relationship between neighbor data points.

4. A system for placing a label on an object in accordance with claim 2, wherein the object recognition processor is arranged to merge the filtered data points into one or more segments associated with an area on the surface of the object.

5. A system for placing a label on an object in accordance with claim 4, wherein the object recognition processor is arranged to compare the merged segments with one or more predefined criterions thereby identifying a candidate label placement position on the surface of the object.

6. A system for placing a label on an object in accordance with claim 4, wherein the object recognition processor is arranged to process the larger merged segment in a higher priority than the smaller merged segment.

7. A system for placing a label on an object in accordance with claim 5, wherein the object recognition processor is arranged to remove the data points far from the surface of the identified candidate label placement position thereby reducing the dimensionality of the data points associated with the identified candidate label placement position.

8. A system for placing a label on an object in accordance with claim 5, wherein the object recognition processor is arranged to sort the priority of the data points among multiple identified candidate label placement position based on one or more predefined criterions.

9. A system for placing a label on an object in accordance with claim 8, wherein the predefined criterion includes sorting the data points based on the distance of the candidate label placement position from centroid of the object.

10. A system for placing a label on an object in accordance with claim 5, wherein the object recognition processor is arranged to compare the surface area of the candidate label placement position with the surface area of the label.

11. A method for placing a label on an object comprising the steps of:
capturing an image of a real-world environment with an object for placement of a label;
processing the captured image with an object recognition process to identify the point clouds associated with an area on the surface of the object;
determining a suitable label placement position based on the combination of the identified point clouds and predefined parameters associated with the label; and
applying the label onto the suitable label placement position such that the label is adhere to the object.

12. A method for placing a label on an object in accordance with claim 11, wherein the object recognition process is arranged to filter the data points of the point clouds from the identified point clouds based on a predefined parameter thereby removing data point irrelevant to the object from the captured image.

13. A method for placing a label on an object in accordance with claim 12, wherein the object recognition process is arranged to undergo the localized filtering based on the relationship between neighbor data points.

14. A method for placing a label on an object in accordance with claim 12, wherein the object recognition process is arranged to merge the filtered data points into one or more segments associated with an area on the surface of the object.

15. A method for placing a label on an object in accordance with claim 14, wherein the object recognition process is arranged to compare the merged segments with one or more predefined criterions thereby identifying a candidate label placement position on the surface of the object.

16. A method for placing a label on an object in accordance with claim 14, wherein the object recognition process is arranged to process the larger merged segment in a higher priority than the smaller merged segment.

17. A method for placing a label on an object in accordance with claim 15, wherein the object recognition process is arranged to remove the data points far from the surface of the identified candidate label placement position thereby reducing the dimensionality of the data points associated with the identified candidate label placement position.

18. A method for placing a label on an object in accordance with claim 15, wherein the object recognition process is arranged to sort the priority of the data points among multiple identified candidate label placement position based on one or more predefined criterions.

19. A method for placing a label on an object in accordance with claim 18, wherein the object recognition process is arranged to sort the data points based on the distance of the candidate label placement position from centroid of the object.

20. A method for placing a label on an object in accordance with claim 15, wherein the object recognition process is arranged to compare the surface area of the candidate label placement position with the surface area of the label.
